(19) United States
(12) Patent Application Publication
(10) Pub. No.: US 2009/0242429 A1
(43) Pub. Date: Oct. 1, 2009

(54) Electrochemical Biosensor

(76) Inventors: Ravil Sitdikov, Albuquerque, NM (US); Dmitri Ivnitski, Albuquerque, NM (US); Gabriel Lopez, Albuquerque, NM (US); Briana Ramirez, Lima, OH (US); Plamen Atanassov, Albuquerque, NM (US)

Correspondence Address: GONZALES PATENT SERVICES, 4605 CONGRESS AVE. NW, ALBUQUERQUE, NM, 87114, US

(21) Appl. No.: 12/349,857

(22) Filed: Jan. 7, 2009

Related U.S. Application Data
(60) Provisional application No. 61/010,227, filed on Jan. 7, 2008.

(51) Int. Cl. G01N 27/26

(52) U.S. Cl. 205/792; 204/403.06; 977/742

(57) ABSTRACT

A simple, fast, selective and highly sensitive electrochemical method assay and disposable device for detection of viruses, bacteria, proteins, DNA, and/or organic/inorganic compounds. The sensor has a multi-layered construction, with each successive layer performing a different function. The design further allows for the packing of numerous microscopic electrode transducers onto the small footprint of a biochip device, allowing for a high-density array of sensors.

### CROSS-REFERENCE TO RELATED APPLICATIONS

The following application claims benefit of U.S. Provisional Patent Application No. 61/010,227, filed Jan. 7, 2008, which is hereby incorporated by reference in its entirety.

### STATEMENT REGARDING GOVERNMENT SPONSORED RESEARCH

This invention was made with Government support under Grants Nos. DMR-0611616 and CTS-0332315, both awarded by the National Science Foundation. The U.S. Government has certain rights in this invention.

### BACKGROUND

1. Field of the Invention

The invention relates to the fields of electrochemical flow-through sensor technology and molecular diagnostics. More particularly, the invention relates to three dimensional, flow-through, disposable sensors for detecting and quantifying viruses, bacteria, proteins, DNA, or compounds such as pollutants, illegal drugs, etc. in air, water, food and complex biological mediums such as blood or saliva in real-time.

2. Description of the Related Art

The need to improve the quality and accessibility of care while reducing costs is widely recognized as a significant challenge currently faced by the nation's health care system. Significant improvements in health care accessibility, quality, and cost are possible through the merging of scientific expertise in miniaturization with knowledge of specific clinical needs in decentralized health care settings.

Conventional assay systems that can detect viruses have been known for some time. However, many current assay systems suffer from interference caused by background sample material. The time and labor required for assay is so great that the assays are not useful and less sensitive means of analysis are employed. For example, the standard method of diagnosis for influenza infection is isolation of the virus by culture from respiratory secretions, which may take several days. The immunoassay approach is based on capturing influenza virus on a solid substrate that has been functionalized with receptor molecules (e.g. antibodies) specific to that target, and then attachment of labels that produce some type of detectable signal to the captured target molecules. Traditionally, both the capture and labeling steps in such an assay are accomplished using biomolecular recognition between the target molecule and specific antibodies, with the label most often including an enzyme, or fluorescent molecules. One rapid detection test for influenza viruses was antigen detection by indirect immunofluorescence assay (IFA) (Microscan; Bartels Viral Respiratory Screening and Identification, Baxter Laboratories, West Sacramento, Calif.), which detects both influenza A and B viruses. However, this test required about 4 h to perform and required a fluorescence microscope and a senior technician experienced in the reading of immunofluorescence slides. Tests for rapid diagnosis of influenza A and B virus by direct or indirect immunofluorescence assay on exfoliated nasopharyngeal cells have shown variable sensitivity (40 to 100%), specificity (86 to 99%) (6-10) and requires complicated and expensive instruments. These assays are difficult to conduct in the non-laboratory conditions typically encountered in a field setting or a remote location. Both direct and indirect immunofluorescence antibody tests can produce a high frequency of false negative results caused by the low sensitivities of the tests compared with viral culture. The accuracy of the clinical diagnosis of influenza is limited, even during peak influenza activity, because other co-circulating respiratory viruses (such as adenoviruses, parainfluenza viruses, respiratory syncytial virus, rhinoviruses, human metapneumovirus), or other organisms (such as Streptococcus pneumoniae, Chlamydia pneumoniae and Mycoplasma pneumoniae) can cause symptoms similar to those of influenza viruses. Existing diagnostic ELISA tests are also not sensitive enough and detect proteins at levels corresponding to advanced stages of the disease. Thus, these kinds of diagnostic tools have several shortcomings that must be overcome: 1) they are slow to recognize the presence of a target virus; 2) they lack adequate sensitivity; 3) the bioanalytical systems are often transportable rather than portable and require highly trained personnel to properly operate them. Other limitations are the complexity of the instrumentation, and the multi-step and time consuming procedures that are always required. In addition, running these instruments is both expensive and labor-intensive.

To overcome this gap, new diagnostic systems must be developed that are more appropriate in healthcare. Smaller, faster, and cheaper (one-step) biosensor devices with high sensitivity and reproducibility are highly desired for replacing time-consuming laboratory-analyses. For instance, rapid detection and identification of both types of influenza infections (A and B viruses) in clinical samples, water, food or air is of great significance in the medical, food and water safety-testing, and environmental monitoring fields. The rapid detection of influenza viruses would allow appropriate antiviral therapy and is particularly important, since agents active against both influenza A and B are now available. Rapid detection also may decrease the use of antibiotics in patients with respiratory tract infections. The ability to use one sample for multiple tests is advantageous to the patient and to health care professionals. Portable, personal use, highly sensitive and fast bioanalytical devices/sensors are urgently needed for early diagnostic and treatment different diseases. Making analytical results available at patient bedside within few minutes will greatly improve the monitoring of disease progress and patient therapy.

During the last few years, a significant number of publications have dealt with alternative electrochemical immunoassay techniques. Electrochemical biosensors have played a major role in the move towards simplified testing, including home-use devices. For example, easy-to-use self-testing glucose strips coupled to pocket-size amperometric meters, have dominated the $5 billion/year diabetes monitoring market over the past two decades. Such disposable enzyme electrodes generate the analytical information within 5-10 seconds in connection to 0.5-10 ul fingerstick blood samples. Thus, the attractive properties of electrochemical biodevices are extremely promising for improving the efficiency of diagnostic testing and therapy monitoring, and for point-of-care diseases testing. Smaller, faster (one-step), and cheaper three dimensional bioanalytical devices are highly desired for replacing time-consuming laboratory-analyses.

### SUMMARY

Various embodiments of the present disclosure provide a simple, fast, selective and highly sensitive electrochemical method assay and disposable device for detection of viruses, bacteria, proteins, DNA, and/or organic/inorganic compounds. The sensor of the invention is of a multi-layered construction, with each successive layer performing a different function. Miniaturization allows packing of numerous microscopic electrode transducers onto a small footprint of a biochip device, and hence the design of high-density arrays.

The present disclosure improves upon previous target analyte assays by requiring fewer steps, detecting specific targets at lower concentrations, and needing less time to complete. The inventions of the present disclosure can be used in field conditions, outside of a well-equipped laboratory setting. Complex instrumentation is not required because the probes and sensors may be used with an inexpensive, hand-held meter. This unique assay approach greatly reduces unwanted background signal, enabling the rapid identification of captured biomolecules with high sensitivity and specificity with little or no sample processing.

Accordingly, in one embodiment, the present disclosure provides an improved biosensor and method for the simultaneous conduct of a multiplicity of binding reactions on a substrate.

In another embodiment, a substrate is a microfabricated device comprising a set of discrete and isolated regions on the substrate, such that each discrete and isolated region corresponds to the location of a binding reaction.

In some embodiments, the detection of the bound regions in which the binding has taken place yields a pattern of binding capable of allowing for the identification of the molecular species in the test sample.

According to another embodiment, the present disclosures provides a method of producing an easy to use miniaturized flow-through device that, among other features, significantly decreases the time of assay and significantly improves sensitivity and the reproducibility of results.

According to yet another embodiment, the present disclosure provides a disposable flow-through immunoassay device that is adapted for use in remote locations.

According to still another embodiment, the present disclosure provides an assay system that can simultaneously detect multiple viruses in real-time.

Accordingly, examples of advantages for the various embodiments of the novel electrochemical biosensor disclosed herein as compared to known flat surface designs include, but are not limited to:
1. improved sensitivity of assay due to large surface area to volume ratio, larger binding capacity and shorter hybridization times
2. accelerated speed of assay significantly due to enhanced mass transport within the microchannels of working electrode (reducing the time required for the target analyte to encounter an immobilized probe from hours to milliseconds; speeding hybridization)
3. ability to efficiently convert bioanalytical signal into electrical due to immobilization of probe molecules directly on the surface of porous electro conductive nanotube network system. Electroconductive nanoparticles (carbon nanotubes, Carbon backs, fulerens and carborans, metal nanoparticles including gold, platinum, silver, nickel, cobalt, or iron) are used as a transducer of electrical signal from biological molecules to the electrode-collector.
4. improved sensitivity of assay due to a double-layer capacitance significantly higher than usually observed for the flat electrode/electrolyte interface.

### BRIEF DESCRIPTION OF THE DRAWINGS

FIG. 1 a schematic representation of a sensor according to a general embodiment of the present disclosure.

FIG. 2 is a schematic representation of an embodiment of a nanoparticle-binding agent detection complex according to the present disclosure.

FIG. 3 is a schematic representation of a sensor according to a first embodiment of the present disclosure.

FIG. 4 is a schematic representation of a sensor according to a second embodiment of the present disclosure.

FIG. 5 is a schematic representation of a sensor according to a third embodiment of the present disclosure.

FIG. 6 is a schematic representation of a sensor according to a fourth embodiment of the present disclosure.

FIG. 7 depicts the alteration of capacitance and interfacial electron transfer resistance of electrodes in response to immobilization of biomaterials when the current-potential relationship associated with the charge transfer process is very small.

FIG. 8 depicts the alteration of capacitance and interfacial electron transfer resistance of electrodes in response to immobilization of biomaterials when the current-potential relationship associated with the charge transfer process is very large.

FIG. 9 is a cross-section of a flow-through electrochemical sensor according to an embodiment of the invention

FIG. 10 is a close-up view of the working electrode used on the sensor of FIG. 10.

FIG. 11 is a cross-section of a flow-through electrochemical sensor according to an embodiment of the invention.

FIG. 12 is a close-up view of the working electrode used on the sensor of FIG. 12.

FIG. 13 is a cross-section of a multiple channel flow-through electrochemical sensor according to an embodiment of the invention.

FIG. 14 is a schematic illustration of a sandwich immunoassay that can be performed using the sensor shown in FIG. 14.

FIG. 15 shows experimental data for a label free immunoassay for influenza A, as described herein.

FIG. 16 shows experimental data for electrochemical detection of anti-influenza A IgG-HRP.

FIG. 17 shows experimental data for detection of anti-influenza A IgG-HRP using an ELISA reader.

FIG. 18 shows the direct detection of Influenza A virus in human nasal clinical samples.

FIG. 19 shows the sensor response in each of the channels of a multi-channel detector.

FIG. 20 shows the results of an anti-chromatin autoantibodies immunoassay.

FIG. 21 shows the results of an anti-chromatin autoantibodies immunoassay.

FIG. 22 shows the results of an anti-chromatin autoantibodies immunoassay.

### DETAILED DESCRIPTION OF THE INVENTION

Miniaturization is the recent trend in analytical chemistry and life sciences. Similar to advances with integrated circuits in the computer industry, the area of biological and chemical analysis is also undergoing a miniaturization effort. A key benefit of miniaturization is the prospect of integration of all of the steps of an analytical process into a single device. Miniaturization of biosensor technologies has intrinsic advantages for improving resolution time (speed of assay), reducing reagent use, and allowing for higher sample throughput. A fusion of micro- and nanotechnology with biology has great potential for the development of low-cost disposable chips for rapid molecular analysis that can be carried out with simple handheld devices.

However, most analytical approaches developed to date are based on the application of two dimensional microchip formats, wherein a suitable set of biological receptor elements (enzyme, antibody, DNA, protein, etc.) are immobilized on the surface of a planar microchip substrate. In two dimensional microchip formats the density of receptor spots is ultimately limited by either the dispensing mechanism or the amount of biological recognition material within each spot. This fact negatively impacts the dynamic range and lower detection limit of analysis. The sensitivity of electrochemical detection based on application of planar microelectrodes is typically low.

Accordingly, as shown in the variously described embodiments, the present disclosure provides a multi-layered three-dimensional flow-through system that generates a detectable electrical signal change in response to the introduction of a target analyte.

FIG. 1 is a schematic representation of an electrochemical sensor according to a general embodiment of the present disclosure. The sensor 20 includes an inert housing 22. Within the housing is an electrode assembly including, for example, a working electrode 24, and a reference electrode 26. The electrode assembly may optionally include an auxiliary or counter electrode 28. A fluid sample is introduced into the sensor via fluid inlet 30 and then passes through working electrode 24. Electrodes 24, 26, and 28 are situated on substrate 32. According to some embodiments, electrodes 24, 26, and 28 may be screen-printed, etched, plated, or layered, using thin-film technologies, onto substrate 32. Of course other known methods of forming sensor 20 may also be used. Sensor 20 includes a fluid inlet 30 that runs normal to the surface of substrate 32. Fluid inlet 30 introduces the fluid sample to working electrode 28. Fluid path 34 allows fluid to flow by or through working electrode 24 and reference electrode 26. As the fluid flows through the sensor, target analyte, if present in the fluid sample, is captured using various mechanisms as described in greater detail below, and presented to the working electrode.

As described in greater detail below, the interaction of the target analyte with the working electrode of the sensors of the present disclosure produces a detectable difference in the electrical signal generated by the electrode. Accordingly, the presently-described sensor allows for rapid detection of the presence or absence of a target analyte in a fluid sample simply by exposing the electrode to target analyte in such a way that the target analyte is able to interact with the electrode and monitoring the electrical signal of the working electrode. This approach does not require the use of any label or conjugate.

Suitable fluid samples include, but are not limited to, blood, blood sera, plasma, urine, saliva, culture medias, tissue extracts, human clinical samples such as nasopharyngeal and throat swabs in viral transport media and combinations thereof. In general, suitable samples may be derived from any bodily fluid. Furthermore, because the sensor is miniaturized and highly sensitive, suitable sample volumes may as small as a few microliters and analyte concentrations as low as a few pc/ml are detectable. In general, suitable sample volumes will be in the microliters to milliliters range and suitable analyte concentrations will be in the pc/ml to mg/ml range. In many cases sample preparation may be as minimal as dilution in buffered saline, or in the case of swabs in viral transport media, not required at all. Accordingly, in many cases, a sample may be taken directly from the patient and applied immediately to the presently described sensor without any additional preparation, allowing the patient to self-test or for care providers to perform tests without requiring additional laboratory equipment.

In some embodiments, working electrode 24 may be modified to increase sensitivity. For example, the working electrode may be coated with an electro-conductive material or film. Examples of suitable electro-conductive coatings include films formed from electro-conductive or semi-conductive nano-particles or carbon nanotube ink, which can increase the electrode surface area more than 100 times. As described in further detail below, the electrode may be further modified by coating the electrode with biological sensing molecules capable of specifically binding to the target analyte. In some embodiments, the working electrode may be coated with a complex comprising both electro-conductive nanoparticles and target-specific binding agents. According to some embodiments, when using a complex of conductive metal or carbon nanoparticles with anti-viral antibody, the biospecific electrical signal can be amplified 10 times or more.

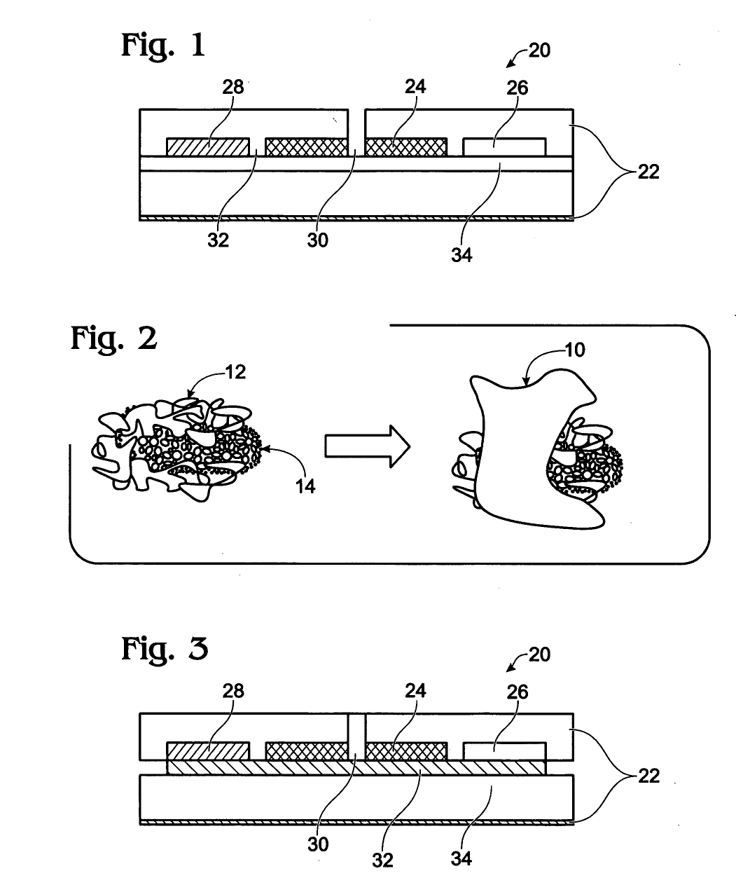

FIG. 2 is a schematic representation of an embodiment of a nanoparticle-binding agent detection complex according to the present disclosure. As shown, an analyte 10 (shown in the depicted embodiment as a virus) is captured by binding agent 12, which may be, for example, as assembled protein monolayer, which is immobilized to the surface of electroconductive nanoparticles 14. The interaction of the analyte with the electroconductive nanoparticles produces a detectable alteration in the capacitance of the nanoparticles.

The electrode capacitance at one frequency can be obtained from the current by means of a lock-in amplifier: C=i/Ew, were C is capacitance, i is the current, E is the amplitude of the ac probe voltage, and w is the angular frequency. Once the target analyte binds to the binding agent, the analyte is brought into contact with the nanoparticles. The biospecific interaction of the analyte on nanoparticle surfaces alters the capacitance and interfacial electron transfer resistance of the nanoparticles, producing an electrical signal, which can then be detected by an electrode. In this manner, the electrical signal differential produced by the presence of the target analyte is amplified significantly.

According to various embodiments, the electroconductive nanoparticles may be formed from metal or carbon as these materials have a double layer capacitance that provides a surface that is more electrically active than other materials. Suitable electroconductive nanoparticles include, but are not limited to, carbon backs, fulerens, and carborans, and metal nanoparticles formed from gold, platinum, silver, nickel, cobalt, iron, or combinations thereof. According to some embodiments, the nanoparticles may be carbon nanotubes.

Examples of suitable binding agents include, but are not limited to, antibodies, receptors, nucleic acids such as DNA, RNA and the like, polypeptides, proteins, polysaccharides, phospholipids, microorganisms, cells, tissue, viruses, bacteriophages, and related natural and unnatural polymers of biological relevance. Those of skill in the art will be familiar with a wide variety of binding agents that are available and will appreciate that the specific binding agent used will be selected based on the desired target analyte.

FIG. 3 is a schematic representation of a sensor according to a first embodiment of the present disclosure. The sensor 20 includes an inert housing 22. Within the housing is an electrode assembly including, for example, a working electrode 24, and a reference electrode 26. The electrode assembly may optionally include an auxiliary or counter electrode 28. It should be noted however, that depending on the method of the electrochemical detection to be performed, the flow-through device may comprise working and reference micro-electrodes only.

A sample may be introduced into the sensor via fluid inlet 30, where it flows through the working electrode 24 and then encounters porous layer 32. In the depicted embodiment, porous layer 32 is in contact with the working, reference, and counter electrodes. In some embodiments, the porous layer may be, for example, an immunoselective membrane having an analyte-specific binding agent immobilized thereto. This ensures that the target analyte, or the product of a reaction between the analyte and its binding agent, is presented to the surface of the working electrode rather than flushed through the system. A wicking or absorbant pad 34 may be used to draw the fluid through the system. Suitable materials for absorbant pad 34 include, but are not limited to cellulose paper, glass fiber media, and hydrophilic polymeric porous media.

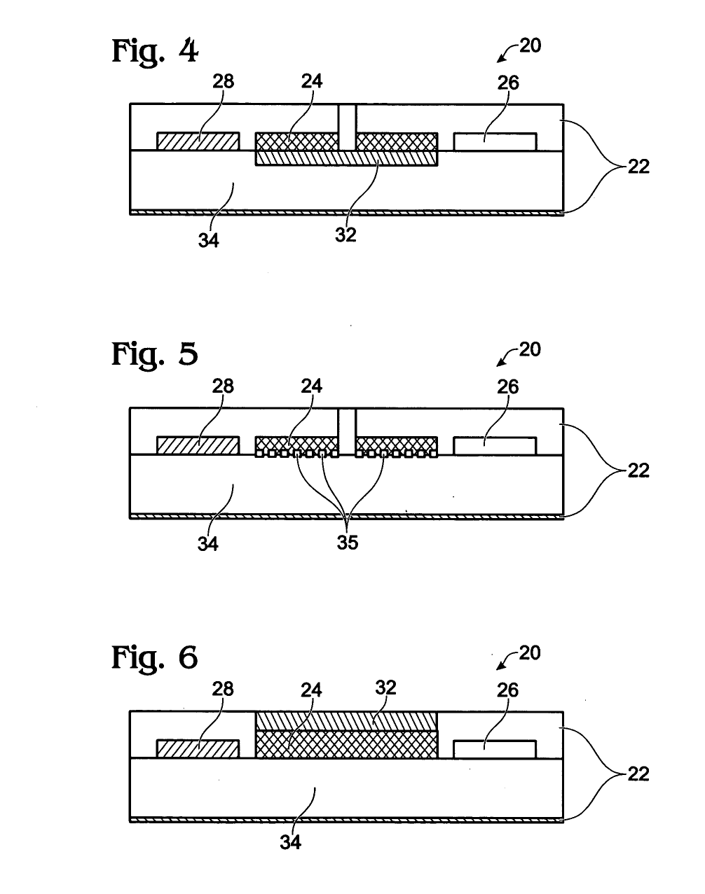

FIG. 4 is a schematic representation of a sensor according to a second embodiment of the present disclosure. In this embodiment, an immunoselective membrane 32 is in contact with and abuts the lower surface of working electrode 24. The immunoselective membrane may include, for example, a target specific binding agent configured to capture the target analyte and present it to the working electrode. Alternatively, the immunoselective membrane may include an agent capable of undergoing a chemical or biological reaction upon exposure to the target analyte, wherein the product of the reaction is presented to the working electrode and produces the altered electrical signal.

FIG. 5 is a schematic representation of a sensor according to a third embodiment of the present disclosure. In this embodiment, the working electrode 24 has a target-specific binding agent 35 immobilized directly onto the surface. The binding agent may be immobilized to the electrode surface using suitable techniques including, but not limited to, passive adsorption and covalent binding. In the depicted embodiment, the working electrode 24 is in direct contact with the absorbent pad 34.

FIG. 6 is a schematic representation of a sensor according to a fourth embodiment of the present disclosure. In this embodiment, the fluid sample is first introduced to an immunoselective membrane 32 which is layered above a porous working electrode 24.

Measurement of the electrical signal can be performed using suitable known methods. The principle of measurement of the biospecific interaction can be divided into two categories: faradic and non-faradic. Faradic measurement requires a redox probe, while non-faradic measurement can be performed in the absence of a redox probe. The electrical contacts can be made on a disposable plastic test strip or on any nonporous insulating substrate using techniques such as screen-printing, vacuum evaporation, lithography, or the like. The biosensor may then be connected to an electronic block via an appropriate line or through a wireless communication system.

As known, a real charge is always associated with physical carriers such as electrons and ions. Each conductor can be characterized by the nature and concentration of the free charges. Electric currents in conductors are directed motions of free charges under the influence of an applied electric field. The conduction can be electronic or ionic, depending on the kind of charges involved. The positively and negatively charged free particles will move in opposite directions when an electric field is applied. A conductor is always electroneutral, i.e., in any part of it the combined density of all charges is zero. The electroneutrality condition is disturbed only within thin layers directly at the interfaces, for example, electrode/electrolyte solution, where excess positive or negative charges can exist in the form of monolayers. When hybridization events occur on an electrode surface the electronic properties of the electrode-solution interface are altered. The transition of charged species (electrons or ions) across the interface is possible in connection with an electrode reaction in which other species may also be involved. As an example, any biospecific interaction (e.g., Ab-virus, Ag-Ab, ligand receptor, DNA-DNA) on the electrode surface can generate electrical signal. This approach does not rely on the use of any label.

Thus, some of the reasons for the signal generation phenomenon include:

1. Charge transfer at the antibody/electrode interface

2. Migration of ions through the protein membrane

3. Diffusion of ions from solution to the electrode surface

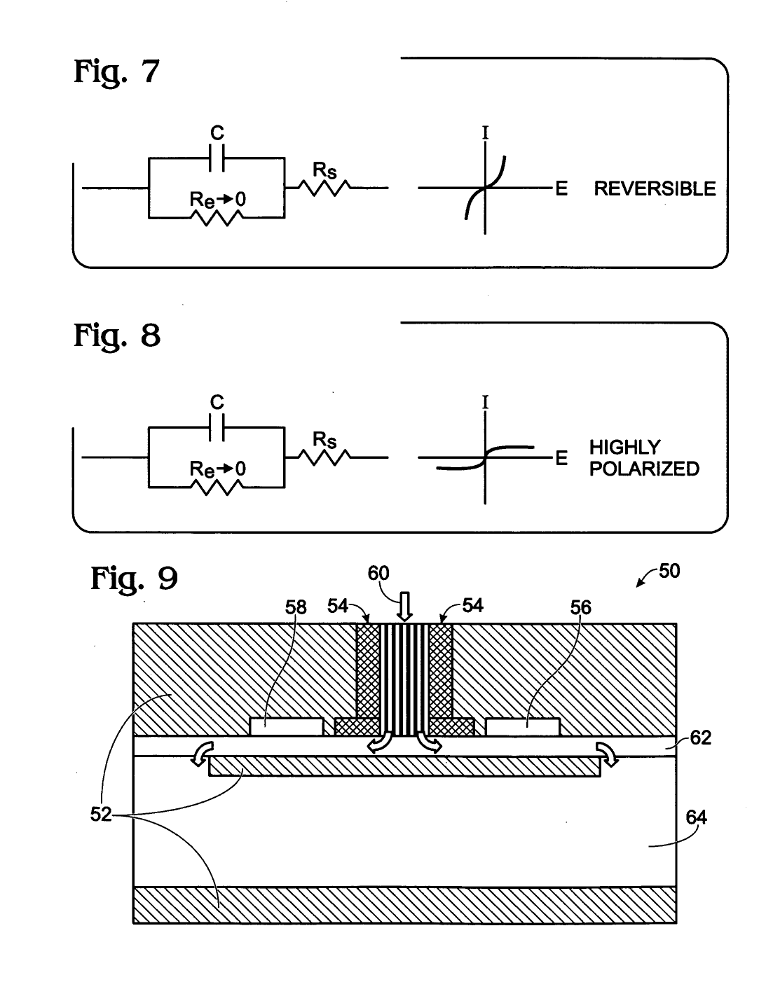

The immobilization of biomaterials, e.g., enzymes, antigens/antibodies, DNA, etc. on electrodes or semiconductor surfaces alters the capacitance and interfacial electron transfer resistance of the conductive or semiconductive electrodes. At low frequency, an electrode coated with a protein layer behaves in a manner analogous to a parallel combination of a capacitor (C) and a resistor (R), and hence can be represented by an electrical equivalent circuit (FIGS. 7 and 8). The (C) represents the capacitance associated with the ionic double layer and is potential dependent. The (R) represents the current-potential relationship associated with the charge-transfer process and is also potential dependent. FIG. 7 corresponds to a situation where R is very small. Any change in the potential causes substantial flow of current until new equilibrium concentrations are established at the interface. FIG. 8 corresponds to a situation where R is very large. Under these conditions the potential across the interface can be changed substantially without causing any significant flow of current.

The electrochemical sensor can operate in a potentimetric, amperometric, or conductometric regime with or without applying a constant or variable potential and monitoring the potential or current associated with the reduction or oxidation of an electroactive species involved in the recognition process. According to an embodiment, a selected volume of sample, for example 5 μl-10 μl, containing an analyte is drawn into a capillary tube and then into the working chamber of an amperometric detector. The physico-chemical change (current or potential, etc.) that is produced as a result of specific interactions between target analyte in the sample, and the complementary biorecognition reagent immobilized on the surface of the working electrode, for example recognition material immobilized on at least some of the microchannels of the element, is detected as a signal. An electrical signal can be shown on the display of the electronic block. Furthermore, the electrical signal detected can be correlated to an amount, concentration, or level of a target analyte in the sample. Accordingly, the present sensor can detect not only the presence or absence of a target analyte, but also the amount, concentration, or level of the target analyte in the sample. FIG. 15, for example, demonstrates a calibration curve for determining influenza A concentration in a sample fluid.

As stated above, according to various embodiments, the electrochemical sensor further utilizes electroconductive nanoparticles as a nano-transducer for direct electrical communication between the target analyte and the micro-electrode surface. In some embodiments, the sensor utilizes a porous electroconductive complex of nanoparticles with a binding agent. The complex of porous electroconductive nanoparticles and binding agent in a three-dimensional flow-through system significantly accelerates the diffusion-controlled rate of biospecific reactions as compared to two-dimensional systems.

According to some embodiments, the electrically conductive nanoparticles may take the form of carbon nanotubules (CNTs). CNTs typically have a diameter in the nanometer range, high chemical stability and a range of electrical conductivity. For these reasons they are excellent conducting “nanowires” for fast charge transfer to an electrode surface. Furthermore, CNTs may undergo surface modification and/or treatment in order to provide an orientation of the target analyte with respect to the electrode.

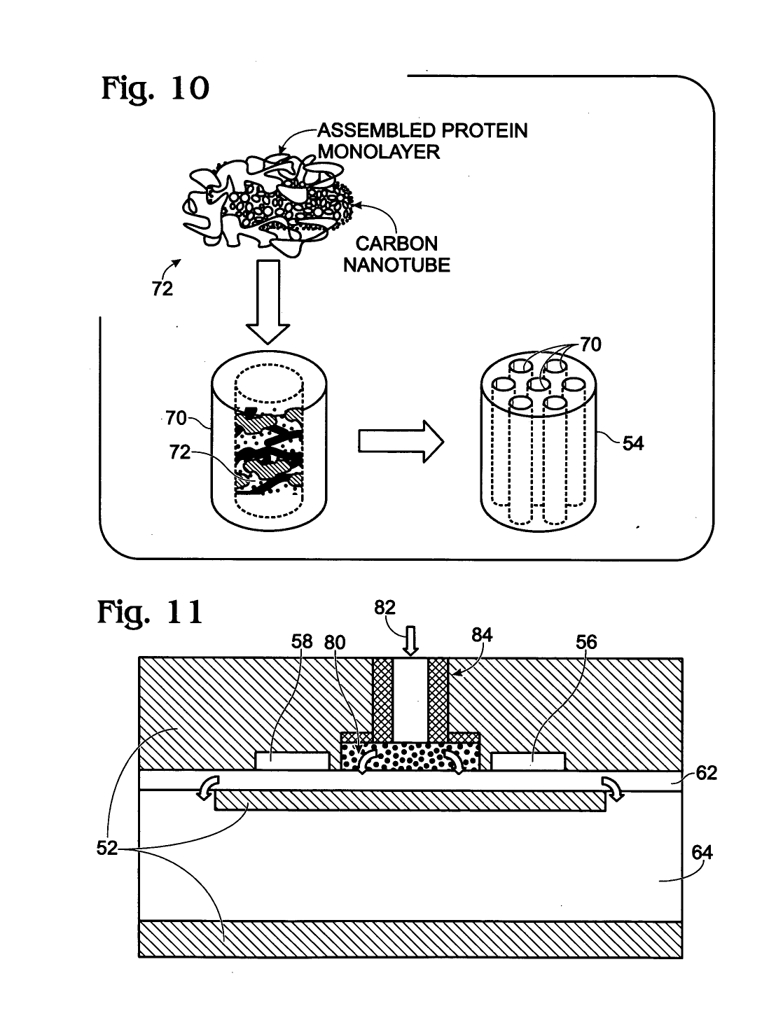

FIGS. 9-11 show cross-sections of a flow-through electrochemical sensor using CNTs according to various embodiments of the invention. Turning first to FIG. 9 the main body of the device 50, as shown, comprises a housing 52, which may be formed from any suitable inert material. An electrode assembly comprises at least one working 54, counter 56, and reference micro-electrode 58. The working and counter electrodes may be carbon or metal electrodes, including platinum, gold, iridium, nickel or combinations of these or other materials. The liquid sample to be tested is introduced to the device via hole 60, which is in the center of the working electrode, the construction of which is described in greater detail with reference to FIG. 10. As the liquid sample enters the device, the flow of the sample is normal to the electrode assembly until it encounters the electrode assembly surface and porous layer 62. The function of porous layer 62 may vary, depending on the nature and complexity of the sample. For example, porous layer 62 may contain one or more assay reagents (antibodies, conjugate) necessary to produce an enzymatic reaction upon exposure to the target analyte. The format of the device allows the product of the enzymatic reaction to accumulate close to the surface of the working electrode without being swept away in the flow of liquid through the device. Fluidic movement through the sensor is encouraged via an absorbent pad 64, which may be formed from cellulose paper, and which is positioned immediately below the porous layer 62.

As shown in FIG. 10 the working electrode 54 includes a plurality of microchannels 70. Electro-conductive nanoparticles with immobilized biological probe (e.g., Abs, Enzymes, DNA, cells, or receptors) 72 are deposited on the inner side surface of the microchannels. As described above, the conductive nanoparticles are used as nano-transducers for direct electrical communication between a target analyte and the electrode surface and due to the high ratio between electrolyte accessible and geometric surface areas, this structure is shown to have a double-layer capacitance significantly higher than usually observed for a flat electrode/electrolyte interface. Therefore, a combination of microchannels with carbon nanotubes and immobilized biological probes generates an immediate electrical signal as a result of biological recognition reactions that occur within the microchannels.

Returning to FIG. 9, porous layer 62 can take the form of a membrane or any suitable material that is sufficient to provide a thin layer of electrolyte between the working, reference and counter electrodes. The pore diameter and thickness of the membrane can be tailored to the requirements of the particular immunoassay and required fluidic behavior to limit the sample volume required for proper direct mediator-less detection of the analyte.

As stated above, sample flows through the microchannels of the working electrode and porous layer, along the surface of counter and reference electrodes and through an absorbent material. Conducting materials which can be suitably connected to a potentiostat or other electroanalytical instrument may further contact the working, counter, and reference electrodes in order to allow for measurement of the electrical signals generated by the electrodes.

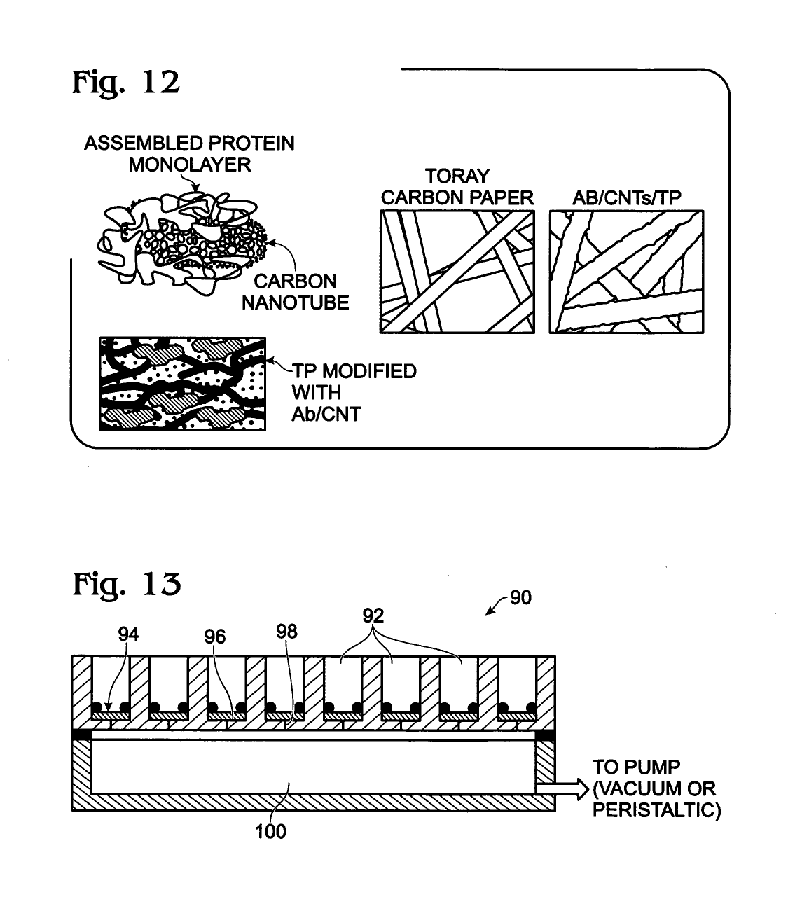

In FIG. 11, the working electrode comprises a single channel which presents the sample to a porous layer 80 comprising Toray Carbon Paper modified with antibodies and carbon nanotubes. FIG. 12 provides a close-up view of the components of porous layer 80. Returning to FIG. 11, it can be seen that after introduction to the sensor via inlet 82 in working electrode 84, the fluid flows through porous layer 80 and then through porous layer 62.

As shown in FIG. 13, the presently-described sensor can be multiplexed to allow for simultaneous assay of multiple samples. In the multi-channel flow-through immunosensor shown in FIG. 13, the sensor 90 includes a plurality of channels 92. The bottom of each channel includes an immunoselective membrane 94 on top of a working electrode 96. The electrode may be formed, for example, by screen printing onto a suitable substrate. A hole 98 in the center of each working electrode allows fluid to flow into waste reservoir 100. Fluid flow may be directed, for example, with the help of a vacuum or peristaltic pump connected to the waste reservoir. As with the previously described embodiments, the immunoselective membrane may contain a target-selective capture agent immobilized thereto. Alternatively, the immunoselective membrane could include a biological agent capable of producing a chemical or biological reaction when exposed to the target analyte. Each channel could include immunoselective membranes having the same or different capture agents, as desired.

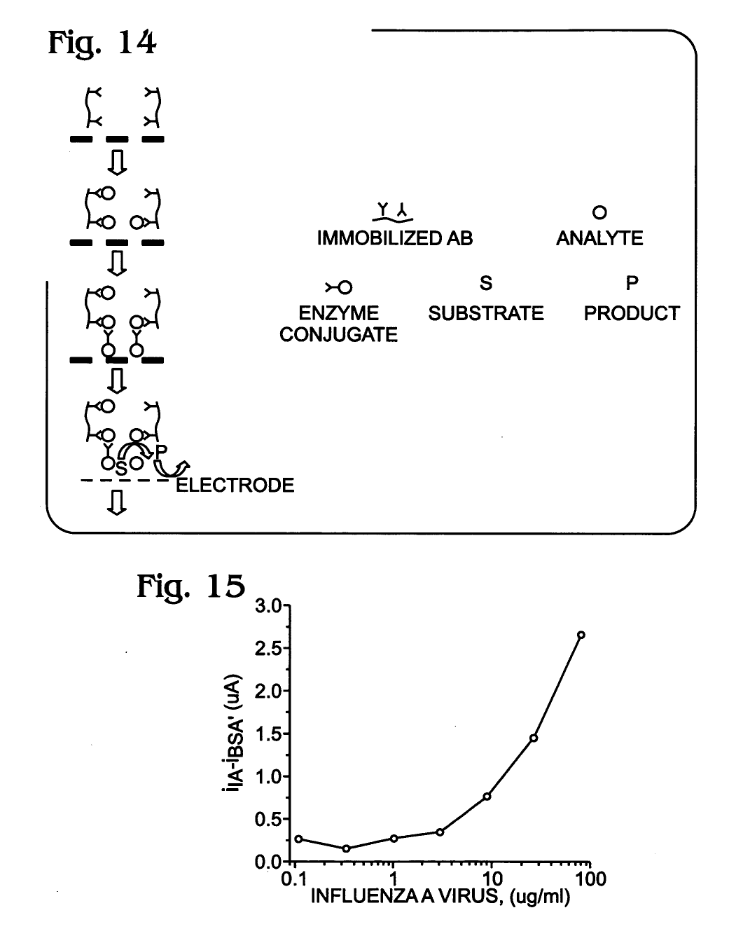

FIG. 14 is a schematic illustration of a sandwich immunoassay that can be performed using the sensor shown in FIG. 13. As shown, the immunoselective membrane includes an immobilized antibody to which an analyte will bind. Upon binding the antibody, the analyte is presented to and allowed to physically interact with the electrode substrate, thereby altering the electrical signal generated by the electrode.

As described in greater detail below with respect to the Examples section, FIG. 15 shows experimental data for a label free immunoassay for influenza A, as described herein.

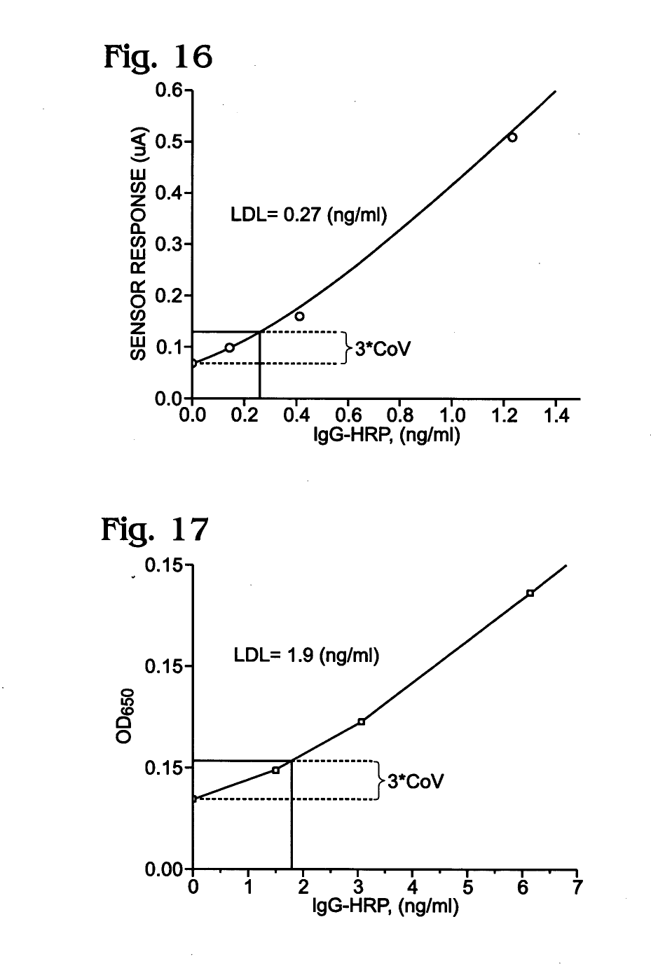

Viewing FIGS. 16 and 17, a comparison of experimental data for detection of anti-influenza A IgG-HRP using electrochemical detection (FIG. 16) and standard ELISA assays (FIG. 17) are shown. The data in FIG. 16 was obtained using an 8-channel electrochemical sensor similar to that shown in FIG. 13. As can be seen, the electrochemical sensor was able to detect much smaller concentrations of IgG-HRP than the standard ELISA assay. Using the electrochemical sensor, the low detection limit (LDL) in 100 uL of sample was 27 pg or 0.142 fmol of igG-HRP. The LDL using the ELISA reader was 1.9 ng/ml.

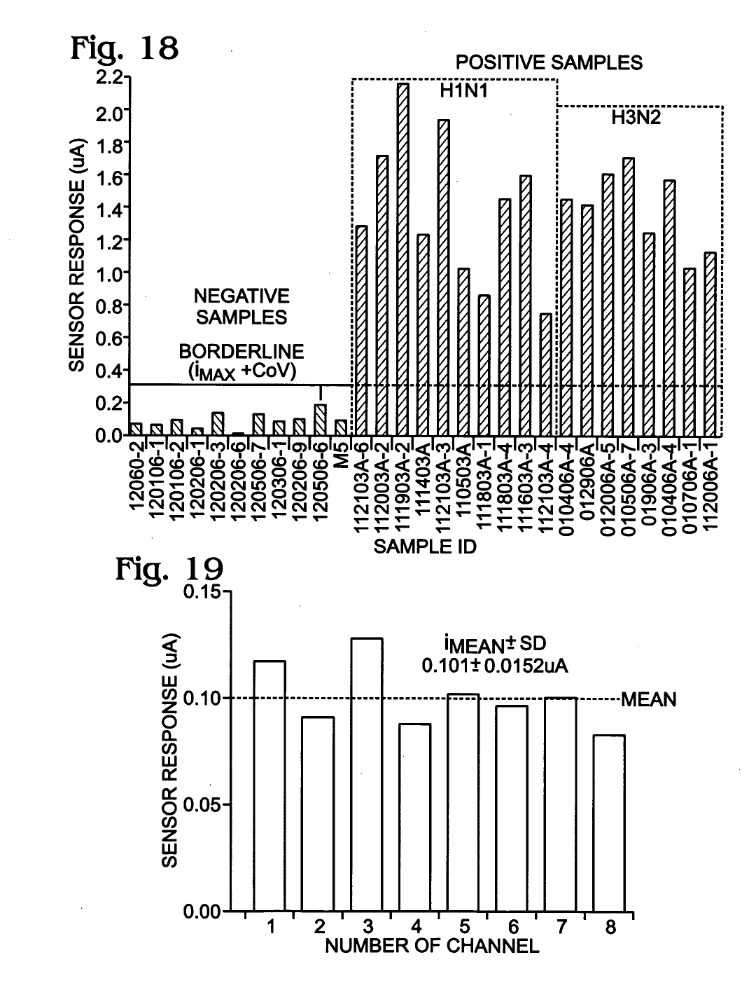

FIGS. 18 and 19 show experimental data obtained from the direct detection of Influenza A virus in human nasal clinical samples, as described in greater detail in the examples section below. The data in FIGS. 18 and 19 was obtained by testing 28 200 uL untreated human samples in M5 transport media. The results showed 100% correlation with the DFA detection method from Tricore Reference Lab.

FIGS. 21-23 show the results of an anti-chromatin autoantibodies immunoassay using a multi-channel electrochemical sensor and methods according to the present disclosure. Again, positive and negative samples were easily distinguished using the presently described methods.

Of course it will be appreciated that any of the electrode configurations shown and described herein can be adapted to be used in single or multi-channel immunosensors.

Accordingly, various embodiments of the present invention provide an electrochemical detection system that uses only a capture probe (antibodies, etc) immobilized onto the three dimensional porous electro conductive surface of a working electrode. An electrochemical flow-through sensor as described in the present disclosure may be used to perform real-time quantitative assays of a wide range of other analytes (enzymes, antibodies, DNA, bacteria, etc.)

All patents and publications referenced or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications. The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. The methods and processes illustratively described herein suitably may be practiced in differing orders of steps, and that they are not necessarily restricted to the orders of steps indicated herein or in the claims. As used herein and in the appended claims, the singular forms “a,” “an,” and “the” include plural reference unless the context clearly dictates otherwise. Thus, for example, a reference to “a host cell” includes a plurality (for example, a culture or population) of such host cells, and so forth.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

### EXAMPLES

The present disclosure may be more readily understood through the following embodiments:

### Example 1

### Detection of Influenza Viruses: Label-Free Detection

Virus Samples. Different concentration virus solutions are prepared from sticks by dilution on 0.01 M phosphate buffer (pH 6.0) containing 0.01 M KCl (assay buffer); influenza type A at different concentrations.

Electrical Measurements. The three-dimensional multi-channel electrochemical flow-thru cells were used for direct electrical detection of influenza viruses. The basic building blocks of biosensor device are biorecognition and transducing elements and the readout modality. The biosensor assembly is comprised of flow-through electrochemical cell, the AndCare 800 8-Well Sensor Strip Reader, which operates by using Intermittent Pulse Amperometry (IPA) and a special software program. The electrode assembly is located perpendicular to the flow of sample through the device. The microchannels of the working electrode contained carbon nanotubes with immobilized antibodies against influenza A virus, on which the immunochemical reaction occurs and output signal is detected. The adsorbent pad provided the means for promoting flow of liquid sample through the device. The current vs. time data were recorded while buffer solutions, or different virus solutions, flowed through the microfluidic channels. The viral sensing experiments were performed in 20 mM phosphate buffer solution (pH 7.4) containing 0.15 M NaCl.

### AndCare 800/8-Well Sensor Strip Reader

AndCare 800/8-Well Sensor Strip Reader (Alderson Biosciences, Inc., Beaufort, N.C.) were used as a major readout device for quantitative flow-through immunoassay with electrochemical detection. The AndCare 800 operates using Intermittent Pulse Amperometry (IPA) and a special software program. The Reader applies intermittent pulses of −100 mV (vs. Ag/AgCl reference electrode) and measures current. The IPA measurements with the AndCare 800 involve a sequence of pulses of the same potential, or different potentials, applied individually to the working electrode at a pre-selected frequency. Current is measured at the end of each pulse and saved in the AndCare 800's memory. When the calibration mode is active, the AndCare 800 converts the difference in current to the corresponding concentration of the analyte using calibration data uploaded from the calibration button. The instrument can be controlled/monitored via two separate data interfaces: user direct or remote computer control. Measurement time is 2 to 240 seconds.

### Intermittent Pulse Amperometry (IPA)

IPA measurement involves a series of millisecond pulses of the same potential applied to the working electrode, separated by longer periods when the electrode is disconnected from the potentiostat circuit. Current signals, which are measured during the last 100 microseconds of each pulse, are significantly larger than those measured by conventional Direct Current Amperometry (DCA). This is due to a reduction of the effect of concentration depletion created by continuously applied potential in DCA. Current measured at the detection pulse is used as an analytical signal for the purpose of detecting the target virus in the test sample. In comparison to Differential Pulse Amperometry (DPA), IPA offers better control of currents measured for one form of a reversible redox couple in the presence of the other form. The benefits of IPA include: 1) Electrochemical signal amplification offers a 10-fold signal amplification in comparison to the DC amperometry, 2) IPA offers significantly faster measurements: 10 s or less, and 3) IPA is ideal for multichannel measurements involving multiarray sensing platforms (multiplexing).

To evaluate the electrochemical flow-through immunosensor, we use a panel of influenza and non-influenza clinical samples which have been characterized either by direct immunofluorescent antibody (DFA) microscopy and/or by polymerase chain reaction (PCR). An inactivated Influenza A virus (strain Texas 1/77H3N2) may be used as an antigen and polyclonal goat anti-Influenza A antibodies, specific for human Influenza A virus strains and conjugated with horseradish peroxidase (BioDesign Int., Saco, Me.), may be used.

The process to prepare the flow-through working electrode starts with the immobilization of primary antibodies onto carbon nanotubes located inside of each microchannels of the working electrode. One hundred microliters (μl) of capture antibody (5 to 30 ug/ml) solution in 0.002M phosphate buffer (pH7.4) containing 0.15M NaCl (PBS) is added to each microchannel. The liquid fraction may be suctioned through the microchannel using a peristaltic pump to apply pressure for 20 sec. Then the working electrodes may be incubated for 20 min at room temperature. The residual antibody solution is removed using peristaltic pump pressure through the electrode assembly for 30 sec. Two hundred μl of 0.5% (w/v) casein (Gallard Schlessinger Scientific Supplies, New York, N.Y.) solution in PBS is suctioned through the microchannels of the working electrode by applying pressure with a peristaltic pump for 1 min. The microchannels of the working electrode are treated with a 0.5% casein solution in PBS for 3 hours at room temperature. The blocking incubation step is followed by washing the flow-through working electrode with a solution of 0.05% (v/v) Tween 20 (Sigma, St. Louis, Mo.) in PBS. After the washing step the working electrode with antibodies immobilized on the surface of carbon nanotubes can be used immediately or stored in a low humidity environment at room temperature.

The protocol for the multichannel flow-through immunoassay used to detect influenza A virus is described below.

### Immunoassay Protocol:

1. Add 200 μl of clinical sample into each well of 8 well Sensor Strip

2. Record results by AndCare multichannel reader in 8 sec.

Injection of control samples without viruses shows no increase or change in current output. However, addition of virus alone or application of nanoparticles without antibodies does not induce such a capacitance change. This demonstrates that the capacitance change is specifically associated with specific interaction of the virus particles with the immobilized antibody layer. Thus, the signal-to-noise ratio is quite high. The current impedance biosensor exhibits a logarithmic relationship between the capacitance change and the virus concentration. The experimental data for this label free immunoassay is shown in FIG. 15.

### Example 2

### Enzyme Immunoassay of Influenza A

### Device Layout

The flow-thru biosensor is composed of an array of microporous working microelectrodes. Each working electrode includes microscopic channels and arrays of probes (Abs, Enzymes, DNA, cells, or receptors), which are deposited on the side surface of microchannels. Microporous working electrodes are used both as a matrix for probe immobilization and as a transducer. Sample flows through the microchannels of the working electrodes and biological recognition reactions occur within the microchannels with electrochemical detection following.

Eight well Carbon Sensor Strips (Alderson Biosciences, Inc. Beaufort, N.C.) form arrays of 8 three-electrode independent electrochemical sensor elements made on one plastic support using screen printing technology. Each electrochemical cell (a volume 300 ul) consists of carbon working, counter, and silver reference electrodes. The 8-well sensor strip is used as disposable 8-channel probes for a multiplexed quantitative flow-through immunoassay with electrochemical detection. The 8-Well Carbon Sensor Strips can be used in a membrane-based or membrane-less, flow through immunoassay design.

The AndCare 800 8-Well Sensor Strip Reader (Alderson Biosciences, Inc., Beuafort, N.C.) is a portable, handheld, single-key and battery-operated instrument for quantitative 8-well sensor strip detection of specific proteins, and antigens. When used in conjunction with disposable 8-well sensor strips, this product enables practical and affordable multi-assay or multi-analyte measurement. The AndCare 800 operates using Intermittent Pulse Amperometry (IPA). IPA allows continuous and simultaneous measurements using sensor elements consisting of several independent sensors. IPA measurements with the AndCare 800 involve a sequence of pulses of the same potential, or different potentials, applied individually to each of the 8 working electrodes at a pre-selected frequency. Current is measured at the end of each pulse and for each of the sensors on the strip a final current is calculated and saved in the AndCare 800's memory. When the calibration mode is active, the AndCare 800 converts the differences in current to the corresponding concentration of the analyte using calibration data uploaded from the calibration button. The instrument can be controlled/monitored via two separate data interfaces: user direct or remote computer control. Measurement time is 2 to 240 seconds. AndCare 800/8-Well Sensor Strip Reader will be used as a major readout device for multiplexed quantitative flow through immunoassay with electrochemical detection.

### IPA Detection

The AndCare 800 Reader operates using Intermittent Pulse Amperometry (IPA). IPA is a new electrochemical detection technique developed at Alderon Biosciences, Inc. for sensitive detection of enzyme labels in DNA assays and immunoassays. IPA measurement involves a series of millisecond pulses of the same potential applied to the working electrode, separated by longer periods when the electrode is disconnected from the potentiostat circuit. Current signals, which are measured during the last 100 microseconds of each pulse, are significantly larger than those measured by conventional Direct Current Amperometry (DCA). This is due to reduction of the effect of concentration depletion created by continuously applied potential in DCA. In comparison to Differential Pulse Amperometry (DPA), IPA offers better control of currents measured for one form of a reversible redox couple in the presence of the other form. When, for example, TMB+ formation by the HRP enzyme is used for a mediated detection of HRP label, small concentrations of TMB+ must be measured in presence of large excess of the reduced from of TMB. IPA offers superior sensitivity in this measurement relative to DC Amperometry while Differential Pulse Amperometry cannot be used because TMB is also electroactive. Other attributes of IPA include: 1) Electrochemical signal amplification offers a 10 fold signal amplification in comparison to the sensitivity of DC amperometry, 2) IPA offers faster measurements: approximately 10 s or less, and 3) multiplexing, IPA is ideal for multichannel measurements involving multiarray sensing platforms.

In the final step of the assay, the amount of enzyme label bound to the membrane is measured using a stabilized mixture of 3,39,5,59-tetramethylbenzidine (TMB) and hydrogen peroxide (H2O2). The monitor applies intermittent pulses of −100 mV (vs a Ag/AgCl reference electrode) and measures current attributable to the electroreduction of TMB+ formed from TMB in a catalytic cycle involving HRP, H2O2, and TMB.

The flow-though electrochemical biosensor has been evaluated for detection and identification of Influenza A in clinical samples. A sandwich immunoassay format using both monoclonal and polyclonal antibodies is used along with peroxidase or an alkaline phosphatase label. The biosensor operates by applying a potential and monitoring the current associated with the reduction or oxidation of an electroactive species involved in the recognition process. An electrical signal is shown on the display of the electronic block and that is correlated to an amount, concentration, or level of a target analyte in the sample.

The process starts with the immobilization of primary antibodies onto nylon based membranes. Membrane strips with immobilized antibodies are placed into the 8-channel flow-through chamber. One hundred microliters (μl) of capture antibody (5 to 30 ug/ml in 0.002M phosphate buffer (pH7.4) containing 0.15M NaCl (PBS) is added to each well. The liquid fraction is suctioned through the nylon membrane using a peristaltic pump to apply pressure for 20 sec. Then antibodies are adsorbed to the membrane for 20 min at room temperature. The residual antibody solution is removed using a peristaltic pump pressure through the membrane for 30 sec. Two hundred μl of 0.5% (w/v) casein solution in PBS is suctioned through membrane by applying pressure with a peristaltic pump for 3 min. The membrane strip is incubated in a 0.5% casein solution in PBS for 3 hours at room temperature. The blocking incubation step is followed by washing the strip with a solution of 0.05% (v/v) Tween 20 (source) in PBS. After the washing step the membrane strip with immobilized antibodies can be used for assay.

The protocol for the multichannel flow-through immunoassay used to detect influenza A virus is described below. The target analyte is an inactivated Influenza A virus (strain Texas 1/77H3N2). The antibodies used in the experiment are polyclonal goat anti-Influenza A antibodies, specific for human Influenza A virus strains, that are conjugated with horseradish peroxidase (BioDesign Int., Saco, Me.). This influenza antigen preparation is sonicated with a microtip for 30 seconds immediately prior to use to ensure a uniform non-clumping preparation.

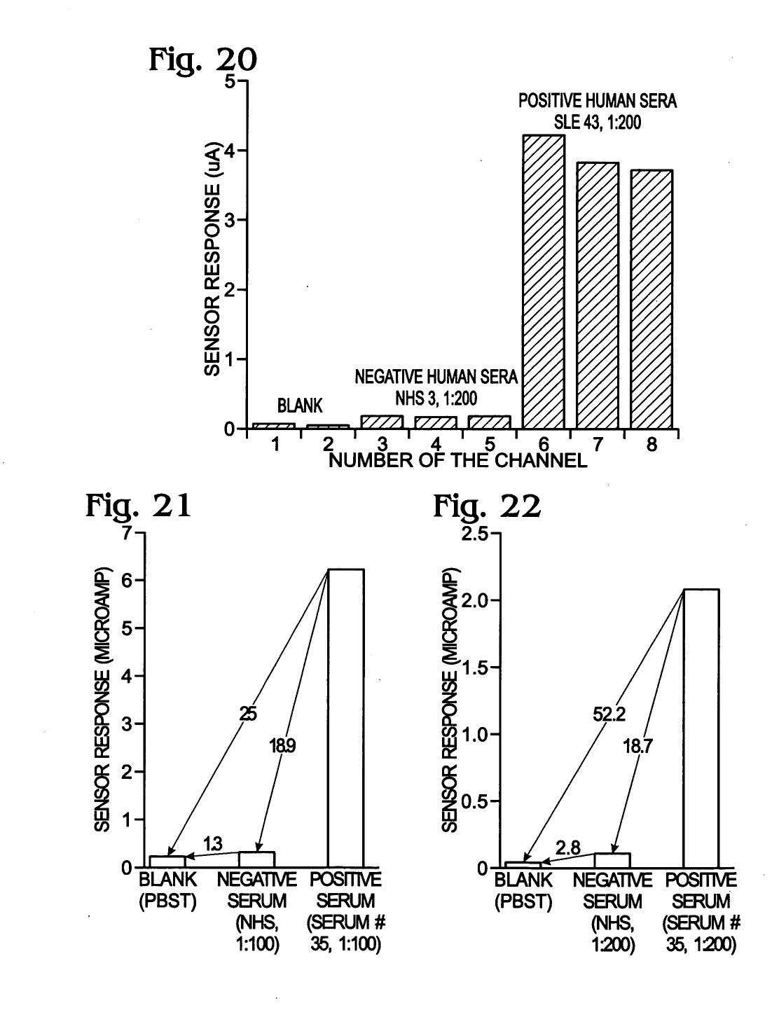

The protocol for the flow-through immunoassay is as follows:
1. Add 200 μl of clinical sample into each well of flow-through multichannel sensor
2. Turn ON peristaltic pump. Pump has to be ON till end of analysis.
3. When wells are empty add 200 μl of PBST, repeat this step two times more.
4. Add to each well 200 μl of HRP-labeled goat anti-influenza antibodies diluted 1:1000 in PBST with 0.01 bovine gamma globulin and 0.1% BSA.
5. When wells are empty add 200 μl of PBST to each well, repeat this step three times.
6. When wells are empty add 100 μl of undiluted TMB solution to each well. Recording of results by AndCare multichannel reader in 8 sec.
   Data from this assay is presented in FIGS. 19 and 20. For the assays shown in FIGS. 18 and 19, 38 untreated human clinical samples from nasopharyngeal swabs in viral transport media, were used.

Analysis of influenza A viruses (H1N1, H3N2) shows that this microarray-based approach is capable of the rapid identification of all types and subtypes of viruses in real-time. The biosensor is capable of detecting as little as 0.05 nM influenza A in 200 ul sample. The hybridization reaction is enhanced by the dimensionally favorable microenvironment of the porous membrane. The electrochemical immunoassay microsystem displayed well-defined concentration dependence over extremely low levels of the target antigen. The Influenza chip can be updated for new flu strains in less than 24 hours and can identify any known flu strain in as little as 15 minutes, without requiring skilled technicians to operate it. The electrochemical detection system is packaged in a portable battery-operated unit. The array can be used as an adjunct to existing technology or to type difficult or ambiguous samples of flu or to study a flu strain as it migrates through a population. The system can process samples from animals as well as humans.

What is claimed is:

1. A three-dimensional, flow-through sensor with electrochemical detection capabilities, comprising:
a body;
an electrode assembly housed within the body, the electrode assembly comprising a substrate including a working electrode and a counter electrode;
a fluid inlet configured to introduce a fluid sample into the body in a direction that is substantially normal to the electrode assembly substrate;
a fluid path in communication with the fluid inlet, the fluid path being configured to allow fluid to encounter both the working electrode and the counter electrode;
a capture agent configured to present a target analyte in the fluid sample to the working electrode such that an electrical signal generated by the working electrode is altered; and
a detector configured to detect the electrical signal generated by the working electrode.

2. The sensor of claim 1 further comprising an immunoselective membrane in fluidic communication with the fluid inlet and the working electrode.

3. The sensor of claim 1 wherein the working electrode is screen-printed on the substrate.

3. The sensor of claim 1 wherein the capture agent enables physical contact between the target analyte and the working electrode.

5. The sensor of claim 1 wherein the capture agent produces a chemical reaction when exposed to the target analyte and the product of the chemical reaction alters the electrical signal generated by the working electrode.

6. The sensor of claim 1 wherein the working electrode comprises a coating of electro-conductive nanoparticles.

7. The sensor of claim 6 wherein the conductive nanoparticles are carbon nanotubules.

8. The sensor of claim 6 wherein the coating further comprises a plurality of analyte-specific binding agents.

9. The sensor of claim 1 wherein the working electrode comprises a plurality of microchannels and wherein the microchannels are fluidly connected to the fluid inlet such that the fluid sample flows through the microchannels.

10. The sensor of claim 8 wherein the microchannels are coated with a complex of electroconductive nanoparticles and a binding agent.

11. A three-dimensional, multi-channel flow-through sensor with electrochemical detection capabilities, comprising:
a body;
a plurality of fluid channels within the body, each fluid channel having:
an electrode assembly comprising a substrate and a working electrode;
a fluid inlet configured to introduce a fluid sample into the body in a direction that is substantially normal to the electrode assembly substrate;
a capture agent configured to present a target analyte in the fluid sample to the working electrode such that an electrical signal generated by the working electrode is altered; and
a detector configured to detect the electrical signal generated by the working electrode.

12. The sensor of claim 11 wherein the capture agent enables physical contact between the target analyte and the working electrode.

13. The sensor of claim 11 wherein the capture agent produces a chemical reaction when exposed to the target analyte and the product of the chemical reaction alters the electrical signal generated by the working electrode.

14. The sensor of claim 11 wherein the working electrode comprises a coating of electro-conductive nanoparticles.

15. The sensor of claim 14 wherein the conductive nanoparticles are carbon nanotubules.

16. The sensor of claim 14 wherein the coating further comprises a plurality of analyte-specific binding agents.

17. A method for detecting the presence of a target analyte in a fluid sample, the method comprising:
introducing a fluid sample to a sensor comprising:
a body;
an electrode assembly housed within the body, the electrode assembly comprising a substrate including a working electrode and a counter electrode;
a fluid inlet configured to introduce a fluid sample into the body in a direction that is substantially normal to the electrode assembly substrate;
a fluid path in communication with the fluid inlet, the fluid path being configured to allow fluid to encounter both the working electrode and the counter electrode;
a capture agent configured to present a target analyte in the fluid sample to the working electrode such that an electrical signal generated by the working electrode is altered; and
a detector configured to detect the electrical signal generated by the working electrode; and
detecting the electrical signal generated by the working electrode to determine if the target analyte is present in the fluid sample.

18. The method of claim 17 further comprising determining the concentration of target analyte present in the fluid sample.

19. The method of claim 17 where the fluid sample is unlabeled.

20. The method of claim 17 further comprising obtaining a fluid sample from a patient and providing the unaltered fluid sample directly to the detector.
